(19) United States
(12) Patent Application Publication
(10) Pub. No.: US 2021/0282988 A1
(43) Pub. Date: Sep. 16, 2021

(54) WHEELCHAIR

(71) Applicant: Mazda Motor Corporation, Hiroshima (JP)

(72) Inventors: Takashi IWASE, Aki-gun (JP); Isao TODA, Aki-gun (JP)

(73) Assignee: Mazda Motor Corporation, Hiroshima (JP)

(21) Appl. No.: 17/177,219

(22) Filed: Feb. 17, 2021

(30) Foreign Application Priority Data
Mar. 13, 2020 (JP) 2020-043667

(51) Int. Cl. A61G 5/08; A61G 5/10

(52) U.S. Cl. CPC A61G 5/0816; A61G 5/1056

(57) ABSTRACT

The wheelchair includes a pair of body frames and, wheels, cross bars, and a seating portion. The wheels are supported rotatably with respect to the pair of body frames by the pair of body frames. The cross bars are provided so as to extend in the Y-direction across the pair of body frames. The seating portion is attached to the pair of body frames and is the portion on which the wheelchair user sits. In the wheelchair, the body frame and the body frame are movable in the longitudinal direction of the cross bars, respectively. The distance between the body frame and the body frame can be changed by moving the body frames in the longitudinal direction of the cross bars.

### CROSS-REFERENCE TO RELATED APPLICATION

The present application contains subject matter related to Japanese Priority Application 2020-043667, filed in the Japanese Patent Office on Mar. 13, 2020, the entire contents of which being incorporated herein by reference in its entirety.

### BACKGROUND

### Field

The present disclosure relates to a wheelchair and, more particularly, to a foldable wheelchair.

### Description of the Related Background Art

Wheelchairs are used by elderly people, disabled people (particularly, disabled people), and the like. Some wheelchairs can be reduced in size by being folded when loaded on a car or when not used at home.

For example, patent document 1 discloses a wheelchair that can be folded when not used. The wheelchair disclosed in patent document 1 includes a pair of left and right side frames and a cross frame connected to these side frames. The cross frame has a pair of arms disposed at an angle at which they intersect with each other and a pivot that pivotably supports the pair of arms at a substantially middle portion.

In the wheelchair disclosed in patent document 1, the distance between the pair of left and right side frames can be reduced by pivoting the arms about the pivot so that the size when the wheelchair is not used can be reduced.

### Prior Art Documents

### PATENT DOCUMENTS

[Patent document 1] JP-A-2018-940

### SUMMARY

However, in the wheelchair disclosed in the patent document 1 above, the structure concerning folding is complicated, thereby causing an increase in weight. In addition, since the cross frame adopts the structure in which the two arms are pivotally supported by the pivot, even when a carbon material or the like is used to reduce weight, it is difficult to use the carbon material or the like for the pivot portion, thereby narrowing the selection range of the material of the cross frame.

When using a foldable wheelchair, the user or the caregiver that operates the wheel chair may routinely repeat folding and developing. Accordingly, a foldable wheelchair is preferred to be foldable with a simple operation, have a simple structure, and be reduced in weight.

The present disclosure addresses such problems with an object of providing a wheelchair that can be folded by a simple operation, has a simple structure, and can be reduced in weight.

### Means for Solving the Problems

According to an aspect of the present disclosure, there is provided a foldable wheelchair including a pair of first body frame and second body frame; wheels that are supported rotatably with respect to the first body frame and the second body frame by the first body frame and the second body frame, respectively; a cross bar that extends across the first body frame and the second body frame; and a seating portion on which a wheelchair user sits, the seating portion being attached to the first body frame and the second body frame, in which at least one of the first body frame and the second body frame is movable with respect to the cross bar in a longitudinal direction of the cross bar, and a distance between the first body frame and the second body frame is changeable by moving the at least one of the first body frame and the second body frame with respect to the cross bar.

In the wheelchair according to the aspect described above, the cross bar is provided between the first body frame and the second body frame. Then, at least one of the first body frame and the second body frame is movable with respect to the cross bar in the longitudinal direction of the cross bar. In the wheelchair according to the aspect described above, the distance between the first body frame and the second body frame is changeable by moving at least one of these body frames with respect to the cross bar. Since the distance between the first body frame and the second body frame can be reduced by simply moving at least one of the body frames with respect to the cross bar in the wheelchair according to the aspect described above, the wheelchair can be folded by a simple operation.

In addition, since the wheelchair according to the aspect described above has a cross bar extending across the first body frame and the second body frame and at least one of the body frames is movable with respect to the cross bar, the cross bar can be formed by a linear member. Accordingly, in the wheelchair according to the aspect described above, the structure can be simplified as compared with the case in which the cross bar connected by a pivot as in the wheelchair disclosed in the patent document 1 is adopted, and the selection range of the material of the cross bar can be widened. Accordingly, in the wheelchair according to the aspect described above, the cross bar may be made of a lightweight carbon material, the weight reduction of the entire wheelchair can be advantageously achieved.

In the wheelchair according to the aspect described above, the seating portion may be detachable from the first body frame and the second body frame.

As described above, by making the seating portion detachable from the first body frame and the second body frame, for example, when the wheelchair is folded and stored in the vehicle or the like, the weight of the portion (unit) to be carried at one time can be reduced by removing the seating portion. Accordingly, the burden on the wheelchair user and the caregiver can be advantageously reduced.

In the wheelchair according to the aspect described above, each of the wheels may include a rim portion that is annular in side view, a hub portion located in the center of the rim portion, and a spoke portion that connects the hub portion and the rim portion to each other, in which the spoke portion may be provided with a guide portion that is inclined with respect to the longitudinal direction of the cross bar and guides an end portion of the cross bar when the wheelchair is folded.

By providing the guide portion in the spoke portion as described above, even if the end portion of the cross bar collides with the spoke portion when the wheelchair is folded, the wheel can be rotated by the force from the cross bar. That is, when the cross bar collides with the inclined guide portion, the direction of the force caused by the collision is aligned with the direction in which the direction of the rotation of the wheel. Accordingly, the wheelchair with the guide portion in the spoke portion can be folded smoothly.

In the wheelchair according to the aspect described above, the cross bar may have a folded portion that allows folding of a portion that projects to an outside of at least one of the wheel rotatably supported by the first body frame and the wheel rotatably supported by the second body frame when the first body frame and the second body frame are closest to each other.

If the folded portion is provided so that the portion of the cross bar that projects to the outside of the wheel can be folded when the wheel chair is folded (when the first body frame and the second body frame are closest to each other) as described above, the width of the entire wheelchair can be reduced, and the wheelchair can be loaded in a small space, for example, when the folded wheelchair is loaded on the vehicle.

In the wheelchair according to the aspect described above, the cross bar may have a separation portion that allows removal of part or all of a portion that projects to an outside of at least one of the wheel rotatably supported by the first body frame and the wheel rotatably supported by the second body frame when the first body frame and the second body frame are closest to each other, from the other portion.

If the separation portion is provided so that the portion of the cross bar that projects to the outside of the wheels can be removed when the wheel chair is folded (when the first body frame and the second body frame are closest to each other) as described above, the width of the wheelchair can be further reduced when the wheelchair is folded. In addition, by removing the portion of the cross bar that projects to the outside of the wheel as described above, for example, when the folded wheelchair is loaded on a vehicle, the weight of the portion (unit) to be carried at one time can be reduced and the burden on the wheelchair user and the caregiver can be advantageously reduced.

In the wheelchair according to the aspect described above, a plurality of cross bars in parallel with each other may make connection between the first body frame and the second body frame, the cross bar being one of the plurality of cross bars.

When the plurality of cross bars in parallel with each other is provided as described above, the rigidity of the wheelchair at the time of use can be further increased. That is, as compared to the case in which the first body frame and the second body frame are connected to each other by one cross bar, the deflection and the like of the wheelchair when the wheelchair receives a torsional moment or moves forward can be reduced by connecting the body frames via the plurality of cross bars.

### BRIEF DESCRIPTION OF THE DRAWINGS

FIG. 1 is a perspective view illustrating the structure of a wheelchair according to an exemplary embodiment.

FIG. 2 is a developed perspective view illustrating the wheelchair in which a seating portion has been separated from body frames.

FIG. 3 is a side view illustrating the structure of the left body frame.

FIG. 4 is a front view (partially a sectional view) illustrating the wheelchair having been folded.

FIG. 5 is a perspective view illustrating the structure of a rear wheel, and the portion surrounded by the dot-dot-dash line illustrates a cross section of a spoke.

FIG. 6A illustrates the function of the guide portion of the spoke. FIG. 6A is a sectional view illustrating the cross-section of the guide portion in the state in which the end portion of the cross bar collides with the guide portion of the spoke.

FIG. 6B illustrates the function of the guide portion of the spoke. FIG. 6B is a side view illustrating the movement of the rear wheel after the end portion of the cross bar collides with the guide portion.

FIG. 7A is a plan view illustrating a wheelchair according to a first modification. FIG. 7A illustrates the state in which the wheelchair has been folded.

FIG. 7B is a plan view illustrating the wheelchair according to the first modification. FIG. 7B illustrates the state in which end portions of the cross bars have been also folded.

FIG. 8A is a plan view illustrating a wheelchair according to a second modification. FIG. 8A illustrates the state in which the wheelchair has been folded.

FIG. 8B is a plan view illustrating the wheelchair according to the second modification. FIG. 8B illustrates the state in which the end portions of the cross bars have been removed.

An exemplary embodiment will be described below with reference to the drawings. It should be noted here that the embodiment described below is an example of the present disclosure and the present disclosure is not limited to the following embodiment except the essential structure thereof.

### DETAILED DESCRIPTION

### 1. Structure of Wheelchair 1

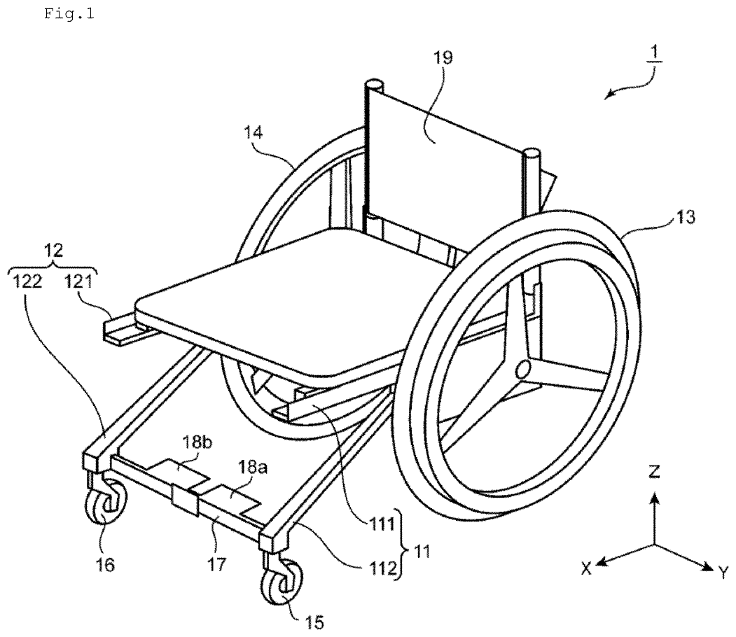

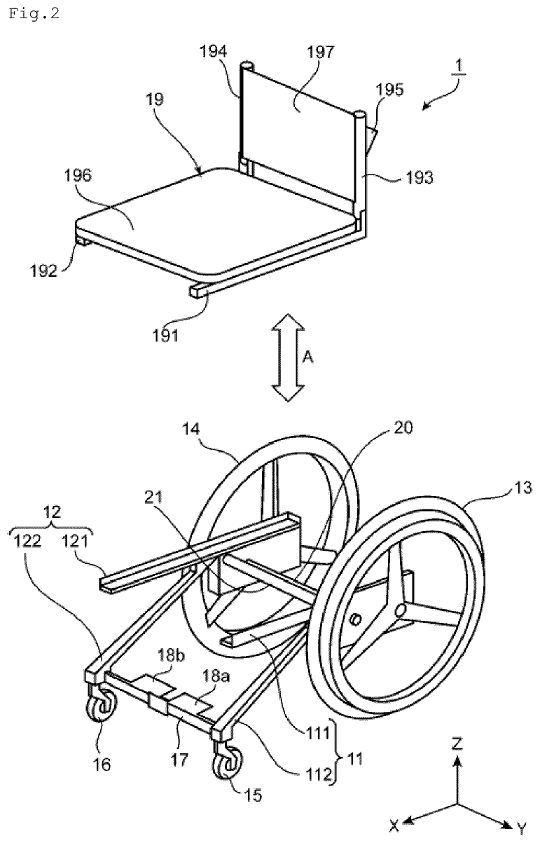

FIG. 1 is a perspective view illustrating the structure of a wheelchair 1 according to an exemplary of the present disclosure. FIG. 2 is a developed perspective view illustrating the wheelchair 1 in which a seating portion 19 has been separated from body frames 11 and 12.

As illustrated in FIG. 1, the wheelchair 1 according to an exemplary embodiment includes a left body frame (first body frame) 11, a right body frame (second body frame) 12, a left rear wheel 13, a right rear wheel 14, a left front wheel 15, a right front wheel 16, a footrest frame 17, a left footrest 18a, a right footrest 18b, and a seating portion 19. In addition, as illustrated in FIG. 2, the wheelchair 1 has two cross bars 20 and 21, each of which extends across the left body frame 11 and the right body frame 12.

The left body frame 11 has a main frame 111 and a sub-frame 112. The main frame 111 and the sub-frame 112 are joined on one side (the rear side of the wheelchair 1) in the X-direction and the distance between the main frame 111 and the sub-frame 112 increases toward the other side (the front side of the wheelchair 1) in the X-direction. In other words, the main frame 111 and the sub-frame 112 of the left body frame 11 are provided so as to form a V-shape in side view from the Y-direction.

The right body frame 12 also has a main frame 121 and a sub-frame 122. The main frame 111 and sub-frame 112 are also joined on one side (the rear side of the wheelchair 1) in the X-direction and the distance between the main frame 111 and the sub-frame 112 increases toward the other side (the front side of the wheelchair 1) in the X-direction, and the main frame 111 and sub-frame 112 are provided so as to form a V-shape in side view from the Y-direction.

The left rear wheel 13 is supported rotatably with respect to the left body frame 11 by the left body frame 11. The right rear wheel 14 is supported rotatably with respect to the right body frame 12 by the right body frame 12.

The left front wheel 15 is rotatably supported by the end portion in the X-direction of the sub-frame 112 of the left body frame 11. The right front wheel 16 is rotatably supported by the end portion in the X-direction of the sub-frame 122 of the right body frame 12.

The footrest frame 17 extends in the Y-direction so as to connect the end portion in the X-direction of the sub-frame 112 of the left body frame 11 and the end portion in the X-direction of the sub-frame 122 of the right body frame 12 to each other. The footrest 18a and the footrest 18b are attached to the footrest frame 17 so as to be disposed side by side at intervals in the Y-direction.

As illustrated in FIG. 2, the seating portion 19 includes a left seat frame 191, a right seat frame 192, a left back frame 193, a right back frame 194, a handle 195, a seat cushion 196, and a seat back 197.

The left seat frame 191 is provided so as to extend in the X-direction on the left side in the Y-direction and can be placed on the main frame 111 of the left body frame 11. The right seat frame 192 is provided so as to extend in the X-direction on the right side in the Y-direction and can be placed on the main frame 121 of the right body frame 12.

The left back frame 193 is provided so as to stand upward in the Z-direction from the rear end in the X-direction of the main frame 111 of the left body frame 11. The right back frame 194 is provided so as to stand upward in the Z-direction from the rear end in the X-direction of the main frame 121 of the right body frame 12. The handle 195 is provided so as to connect substantially the middle in the Z-direction of the left back frame 193 and substantially the middle in the Z-direction of the right back frame 194 to each other and project backward in the X-direction of the left back frame 193 and the right back frame 194.

The seat cushion 196 is mounted on the left seat frame 191 and the right seat frame 192. The seat back 197 is attached to the front portions in the X-direction of the left back frame 193 and the right back frame 194.

It should be noted here that, as indicated by arrow A in FIG. 2, the seating portion 19 can be attached to or detached from the left body frame 11 and the right body frame 12.

The cross bar 20 and the cross bar 21 are disposed downward in the Z-direction of the main frames 111 and 121 of the body frames 11 and 12, extend in the Y-direction across the body frame 11 and the body frame 12, and are disposed in parallel with each other.

### 2. Detailed Structure of Body Frames 11 and 12

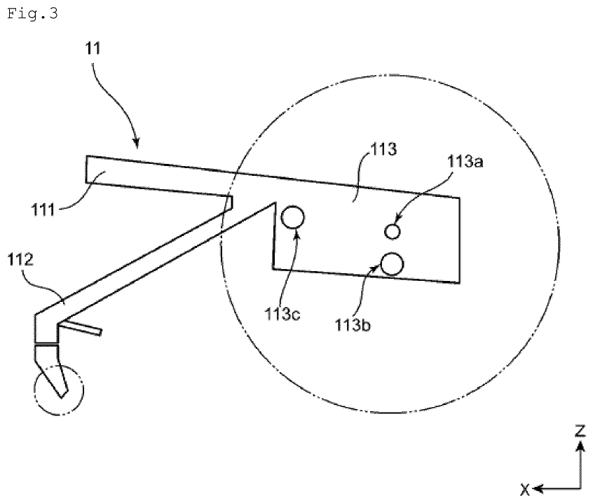

The detailed structure of the pair of left and right body frames 11 and 12 will be described with reference to FIG. 3. Although the left body frame 11 is illustrated as an example in FIG. 3, the right body frame 12 has the same structure, so the right body frame 12 will not be illustrated and described below.

As illustrated in FIG. 3, the left body frame 11 has a support portion 113 in the vicinity of the portion in which the main frame 111 and the sub-frame 112 are joined to each other. The support portion 113 is a substantially planar portion and is provided along the X-direction and the Z-direction.

Three holes 113a, 113b, and 113c are formed in the support portion 113 of the left body frame 11. Of the three holes 113a, 113b, and 113c, the hole 113a is used to rotatably support the left rear wheel 13 (rotatable support hole 113a).

The hole 113b is the hole (bar insertion hole 113b), provided downward in the Z-direction of the rotatable support hole 113a, through which the cross bar 20 (see FIG. 2) passes to enable the left body frame 11 to move in the longitudinal direction of the cross bar 20 with respect to the cross bar 20. The hole 113c is the hole (bar insertion hole 113c), provided forward in the X-direction of the rotatable support hole 113a, through which the cross bar 21 (see FIG. 2) passes to enable the left body frame 11 to move in the longitudinal direction of the cross bar 21 with respect to the cross bar 21. It should be noted here that the bar insertion hole 113c is provided in a position upward in the Z-direction of the bar insertion hole 113b.

### 3. Folding of Wheelchair 1

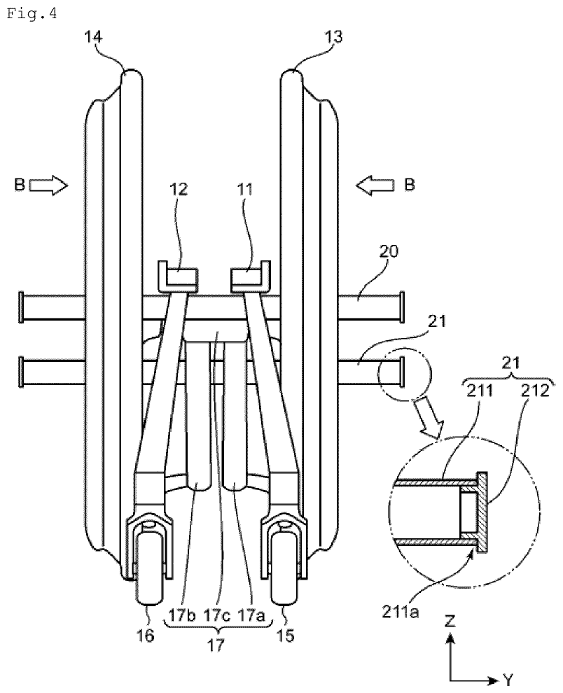

FIG. 4 is a front view (partially a sectional view) illustrating the wheelchair 1 having been folded as seen from the front side in the X-direction.

When the wheelchair 1 according to the embodiment is folded, the seating portion 19 is first removed from the body frame 11 and 12 as illustrated in FIG. 2. It should be noted here that a lock mechanism (latch mechanism) or the like may be provided between the body frames 11 and 12 and the seat frames 191 and 192 of the seating portion 19 so that the seating portion 19 is not removed from the body frames 11 and 12 undesirably.

Next, as indicated by arrow B in FIG. 4, the wheelchair user or the caregiver moves the left body frame 11 and the right body frame 12 in the longitudinal direction (Y-direction) of the cross bars 20 and 21 with respect to the cross bars 20 and 21. This reduces the distance between the left body frame 11 and the right body frame 12. It should be noted here that the left rear wheel 13 and the left front wheel 15 move to the inside in the Y-direction together with the left body frame 11, and the right rear wheel 14 and the right front wheel 16 move to the inside in the Y-direction together with the right body frame 12.

In addition, as illustrated in FIG. 4, the footrest frame 17 includes a left frame 17a, a right frame 17b, and a link portion 17c. When the wheelchair 1 is formed and unfolded, as illustrated in FIG. 2, the left frame 17a, the right frame 17b, and the link portion 17c of the footrest frame 17 extend linearly in the Y-direction.

In contrast, as illustrated in FIG. 4, when the wheelchair 1 is folded, the footrest frame 17 is also folded and the left frame 17a and the right frame 17b stand up in the Z-direction. It should be noted here that the folding of the footrest frame 17 is performed in conjunction with the slide of the body frames 11 and 12 with respect to the cross bars 20 and 21 and do not need special power.

As illustrated in the portion surrounded by the dot-dot-dash line in FIG. 4, the cross bar 21 has a long pipe 211 and caps 212 attached to pipe end portions 211a of the pipe 211.

The outer diameter of the cap 212 is larger than the outer diameter of the pipe 211 when seen from the Y-direction and is larger than the inner diameter of the bar insertion hole 113c (see FIG. 3).

Although not illustrated, the cross bar 20 has the same structure.

By using the cross bars 20 and 21 having the structure described above, the body frames 11 and 12 can be prevented from being detached from the end portions of the cross bars 20 and 21 when, for example, the wheelchair 1 is formed.

### 4. Structure of Rear Wheels 13 and 14

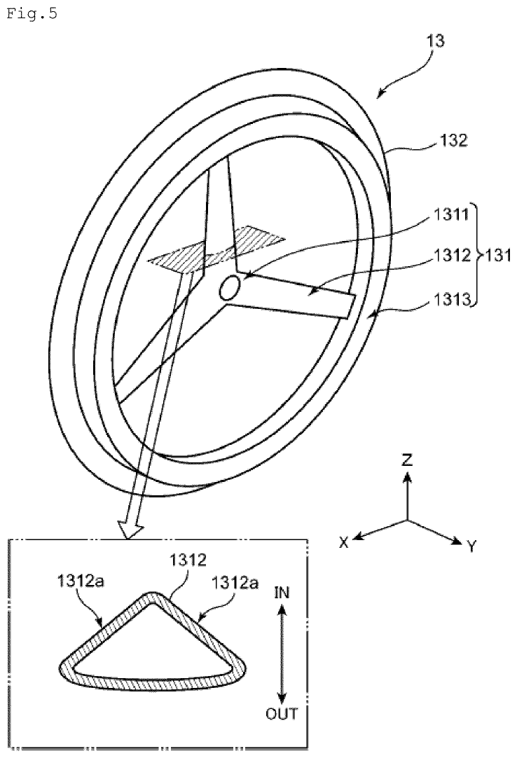

The structure of the rear wheel 13 rotatably supported by the body frames 11 and 12 will be described with reference to FIG. 5. FIG. 5 is a perspective view illustrating the structure of the left rear wheel 13, and the portion surrounded by the dot-dot-dash line in FIG. 5 is a sectional view illustrating a spoke 1312. Although the left rear wheel 13 is illustrated as an example in FIG. 5, the right rear wheel 14 has the same structure, so the right rear wheel 14 will not be illustrated and described below.

As illustrated in FIG. 5, the left rear wheel 13 has a spoke wheel 131 and a tire 132. The spoke wheel 131 includes a hub 1311 rotatably supported by the left body frame 11, the plurality of spokes 1312 extending radially outward from the hub 1311, and an annular rim 1313 connected to the outer ends of the spokes 1312.

Since the individual components of the left rear wheel 13 are schematically illustrated in FIG. 5, a hand rim and the like attached to the spoke wheel 131 are not illustrated.

As illustrated in the portion (the portion indicating the cross-section of the spoke 1312) surrounded by the dot-dot-dash line in FIG. 5, in the wheelchair 1 according to the embodiment, a guide portion 1312a is provided on the spoke 1312 of the spoke wheel 131. The guide portion 1312a is the two-slope portion (the portion inclined with respect to the longitudinal direction of the cross bars 20 and 21) of a substantially triangular cross-section that has an apex on the inside (the side close to the right body frame 12) in the Y-direction and gradually expands toward the outside in the Y-direction.

The guide portion 1312a has an apex on the inside in the Y-direction on the right side of the spoke wheel 131 of the left rear wheel 13, and this apex faces the apex of the guide portion similarly provided on the spoke of the right rear wheel 14. However, at least one of the spoke 1312 of the left rear wheel 13 and the spoke of the right rear wheel 14 may have the guide portion.

### 5. Function of Guide Portion 1312a

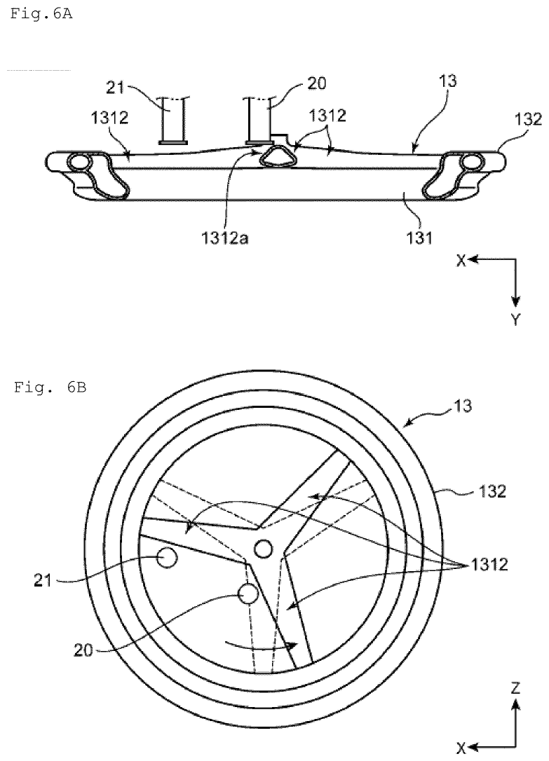

FIGS. 6A and 6B are diagrams illustrating the function of the guide portion 1312a of the spoke 1312. FIG. 6A is a sectional view illustrating the cross-section of the guide portion 1312a in the state in which the end portion of the cross bar 20 collides with the guide portion 1312a of the spoke 1312 and FIG. 6B is a side view illustrating the movement of the left rear wheel 13 after the end portion of the cross bar 20 collides with the guide portion 1312a.

As illustrated in FIG. 6A, when the body frames 11 and are moved toward the cross bars 20 and 21 in the longitudinal direction (Y-direction) of the cross bars 20 and 21 to fold the wheelchair 1, the end portions of the cross bars 20 and 21 may collide with the spokes 1312 depending on the state (the state in the circumferential direction) of the rear wheels 13 and 14. It should be noted here that FIG. 6A illustrates, as an example, the state in which the cross bar 20 collides with the spoke 1312.

If the end portion of the cross bar 20 collides with the guide portion 1312a of the spoke 1312 as illustrated in FIG. 6A when the wheelchair 1 is folded, the force in the Y-direction from the cross bar 20 is applied to the slope portion, which is the guide portion 1312a, and the force in the circumferential direction acts on the spoke 1312. This rotates the left rear wheel 13 including the spoke 131 having received the force from the cross bar 20 due to this collision, as illustrated in FIG. 6B. By providing the guide portion 1312a having the slope portion formed so as to face the inside (the side close to the right body frame 12) in the Y-direction on the spoke 131 as described above, if the ends of the cross bars 20 and 21 make contact with the spoke 1312, the left rear wheel 13 can be rotated as illustrated by the arrow and the state of collision with the cross bar 20 can be eliminated, so the wheelchair 1 can be folded smoothly.

It should be noted here that the three spokes of the right rear wheel 14 also have the same cross-sectional structure and have the same function as above.

### First Modification

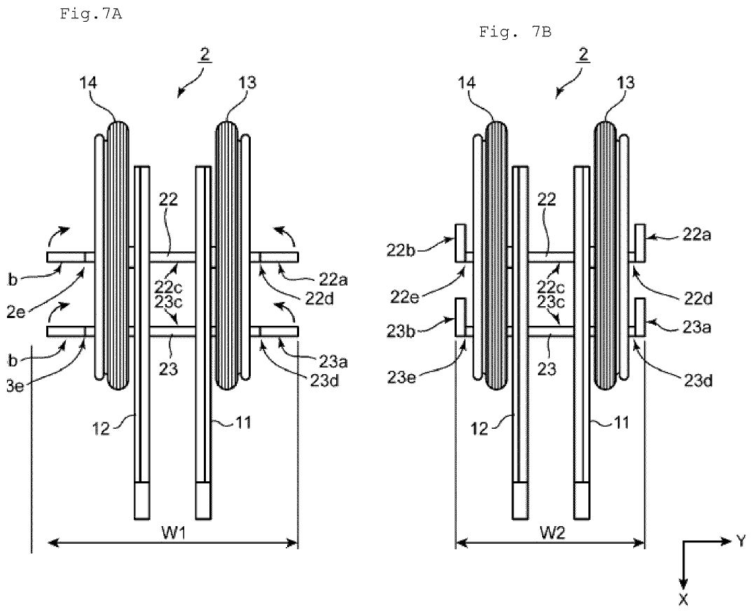

FIGS. 7A and 7B are plan views illustrating a wheelchair 2 according to a first modification. FIG. 7A illustrates the state in which the wheelchair 2 has been folded and FIG. 7B illustrates the state in which end portions 22a, 22b, 23a, and 23b of the cross bars 22 and 23 have also been folded. Since the wheelchair 2 according to this modification has the same structure as the wheelchair 1 according to the embodiment described above except the structures of the cross bars 22 and 23, the same structural portions will not be described.

When the wheelchair 2 is folded as illustrated in FIG. 7A, the body frames 11 and 12 are first moved to the inside in the longitudinal direction (Y-direction) of the cross bars 22 and 23 with respect to the cross bars 22 and 23. This is the same as in the wheelchair 1 according to the embodiment described above.

Next, in the wheelchair 2 according to this modification, the portions (end portions) 22a, 22b, 23a, and 23b that project to the outside in the Y-direction of the rear wheels 13 and 14 due to the movement of the body frames 11 and 12 with respect to the cross bars 22 and 23 are folded using the folded portions 22d, 22e, 23d, and 23e as fulcrums by rotating these end portions about the central portions 22c and 23c as illustrated by the arrows. In the wheelchair 2 according to this modification, the end portions 22a, 22b, 23a, and 23b of the cross bars 22 and 23 can be folded by adopting joint structures or the like as the folded portions 22d, 22e, 23d, and 23e. In addition, the cross bars 22 and 23 have locking mechanisms (not illustrated) that regulate the folding of the end portions 22a, 22b, 23a, and 23b when the wheelchair 2 is formed for use.

By folding the end portions 22a, 22b, 23a, and 23b of the cross bars 22 and 23 as illustrated in FIG. 7B, the width of the wheelchair 2 can be reduced to W2 from W1, which is the width before the end portions 22a, 22b, 23a, 23b are folded. Accordingly, for example, when the folded wheelchair 2 is loaded on a vehicle, the wheelchair 2 can be loaded in a small space and handled easily.

### Second Modification

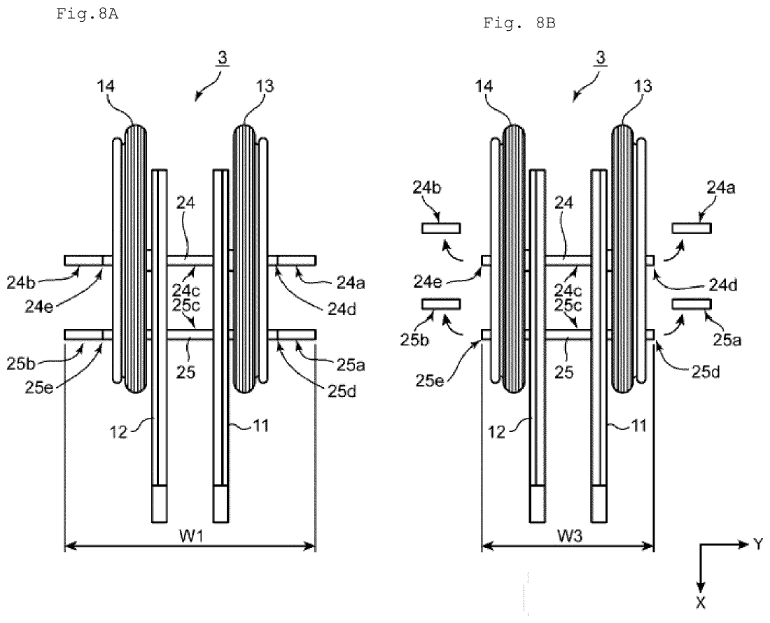

FIGS. 8A and 8B are plan views illustrating a wheelchair 3 according to a second modification. FIG. 8A illustrates the state in which the wheelchair 3 has been folded and FIG. 8B illustrates the state in which the end portions 24a, 24b, 25a, and 25b of the cross bars 24 and 25 have been removed. Since the wheelchair 3 according to this modification has the same structure as the wheelchair 1 according to the embodiment described above except the structure of the cross bars 24 and 25, the structural portions will not be described.

When the wheelchair 3 is folded as illustrated in FIG. 8A, the body frames 11 and 12 are first moved toward the inside in the longitudinal direction (Y-direction) of the cross bars 24 and 25 with respect to the cross bars 24 and 25. This is the same as in the wheelchair 1 according to the embodiment described above.

Next, in the wheelchair 3 according to this modification, the portions (end portions) 24a, 24b, 25a, and 25b that project to the outside in the Y-direction of the rear wheels 13 and 14 due to the movement of the body frames 11 and 12 with respect to the cross bars 24 and 25 are removed from the separation portions 24d, 24e, 25d, and 25e on the outside in the Y-direction of the wheels 13 and 14 as illustrated by the arrows.

By removing the end portions 24a, 24b, 25a, and 25b of the cross bars 24 and 25 from the central portions 24c and 25c as illustrated in FIG. 8B, the width of the wheelchair 3 can be reduced to W3 from W1, which is the width before the end portions 24a, 24b, 25a, and 25b are removed. Accordingly, for example, when the folded wheelchair 3 is loaded on a vehicle, the wheelchair 3 can be loaded in a small space and handled easily.

In addition, by removing the end portions 24a, 24b, 25a, and 25b of the cross bars 24 and 25 from the central portions 24c and 25c, the weight of the portions (units) to be carried at one time can be reduced and the burden on the wheelchair user and the caregiver can be advantageously reduced.

When the wheelchair 3 is folded, all of the portions that project to the outside in the Y-direction of the rear wheels 13 and 14 may be removed or some of the portions may be removed.

### Other Modifications

Although the two cross bars 20 and 21, the two cross bars 22 and 23, and the two cross bars 24 and 25 are provided across the left and right body frames 11 and 12 in the embodiment and the first and second modifications described above, the present disclosure is not limited to these examples. For example, the structure in which one cross bar is provided across a pair of left and right body frames may be adopted or the structure in which three or more cross bars are provided across a pair of left and right body frames may be adopted.

In addition, the cross-sectional shape of the cross bars is not limited to a circular shape and various shapes such as an elliptical shape, an oval shape, and a polygonal shape, etc. may be adopted.

Although the wheelchairs 1, 2 and 3 according to the embodiment and the first and second modifications described above do not include armrests, the present disclosure does not exclude the provision of the armrests. Armrests may be provided in the body frames or the seating portion.

In addition, although brakes are not described in the embodiment and the first and second modifications described above, brakes with various types of structures may be provided. A brake that brakes the tires of the rear wheels using a frictional force or other brakes may be adopted.

In the wheelchairs 1, 2, and 3 according to the embodiment and the first and second modifications described above, both the left and right body frames 11 and 12 are movable with respect to the cross bars 20 and 21, the cross bars 22 and 23, and the cross bars 24 and 25, the present disclosure is not limited to these examples. The structure in which only one body frame (the left body frame or the right body frame) is movable with respect to the cross bars may be adopted.

Although the cross bars 20 and 21 and the cross bars 22 and 23 are still attached to the body frames 11 and 12 even when the wheelchairs 1 and 2 are folded in the wheelchairs 1 and 2 according to the embodiment and the first modification described above and only the end portions 24a, 24b, 25a, and 25b of the cross bars 24 and 25 can be removed in the second modification described above, the present disclosure is not limited to these examples. For example, the structure in which the cross bars can be completely pulled out of the left and right body frames can be adopted when the wheelchairs are folded. For example, when the folded wheelchairs are loaded on a vehicle in such a structure, the weight of the portions (units) to be carried at one time can be reduced, the size of the wheelchair can be reduced, and the burden on the wheelchair user and the caregiver can advantageously be further reduced.

### Advantage of the Disclosure

The wheelchairs according to the aspects described above can be folded by a simple operation, have simple structures, and can be reduced in weight.

### DESCRIPTION OF REFERENCE SIGNS AND NUMERALS

1, 2, 3: wheelchair
11, 12: body frame
113b, 113c: bar insertion hole
131: spoke wheel
1312: spoke
1312a: guide portion
19: seating portion
20, 21, 22, 23, 24, 25: cross bar
22d, 22e, 23d, 23e: folded portion
24d, 24e, 25d, 25e: separation portion

What is claimed is:

1. A foldable wheelchair comprising:
a pair of a first body frame and a second body frame;
wheels that are supported rotatably with respect to the first body frame and the second body frame by the first body frame and the second body frame, respectively;
a cross bar that extends across the first body frame and the second body frame; and
a seat on which a wheelchair user sits, the seat being attached to the first body frame and the second body frame,
wherein at least one of the first body frame and the second body frame is movable with respect to the cross bar in a longitudinal direction of the cross bar, and
a distance between the first body frame and the second body frame is changeable by moving the at least one of the first body frame and the second body frame with respect to the cross bar.

2. The wheelchair according to claim 1,
wherein the seat is detachable from the first body frame and the second body frame.

3. The wheelchair according to claim 2,
wherein each of the wheels includes:
a rim that is annular in side view,
a hub located in the center of the rim, and
a spoke that connects the hub and the rim to each other, the spoke being provided with a guide that is inclined with respect to the longitudinal direction of the cross bar and guides an end of the cross bar when the wheelchair is folded.

4. The wheelchair according to claim 3,
wherein the cross bar has a folding structure that allows folding of a portion that projects to an outside of at least one of the wheels rotatably supported by the first body frame and the wheel rotatably supported by the second body frame when the first body frame and the second body frame are closest to each other.

5. The wheelchair according to claim 4,
wherein the cross bar has a separation structure that allows removal of part or all of a portion that projects to an outside of at least one of the wheels rotatably supported by the first body frame and the wheel rotatably supported by the second body frame when the first body frame and the second body frame are closest to each other, from the other portion.

6. The wheelchair according to claim 5,
wherein a plurality of cross bars in parallel with each other make connection between the first body frame and the second body frame, the cross bar being one of the plurality of cross bars.

7. The wheelchair according to claim 1,
wherein each of the wheels includes:
a rim that is annular in side view,
a hub located in the center of the rim, and
a spoke that connects the hub and the rim to each other, the spoke being provided with a guide that is inclined with respect to the longitudinal direction of the cross bar and guides an end of the cross bar when the wheelchair is folded.

8. The wheelchair according to claim 1,
wherein the cross bar has a folding structure that allows folding of a portion that projects to an outside of at least one of the wheels rotatably supported by the first body frame and the wheel rotatably supported by the second body frame when the first body frame and the second body frame are closest to each other.

9. The wheelchair according to claim 1,
wherein the cross bar has a separation structure that allows removal of part or all of a portion that projects to an outside of at least one of the wheels rotatably supported by the first body frame and the wheel rotatably supported by the second body frame when the first body frame and the second body frame are closest to each other, from the other portion.

10. The wheelchair according to claim 1,
wherein a plurality of cross bars in parallel with each other make connection between the first body frame and the second body frame, the cross bar being one of the plurality of cross bars.

11. The wheelchair according to claim 2,
wherein the cross bar has a folding structure that allows folding of a portion that projects to an outside of at least one of the wheels rotatably supported by the first body frame and the wheel rotatably supported by the second body frame when the first body frame and the second body frame are closest to each other.

12. The wheelchair according to claim 2,
wherein the cross bar has a separation structure that allows removal of part or all of a portion that projects to an outside of at least one of the wheels rotatably supported by the first body frame and the wheel rotatably supported by the second body frame when the first body frame and the second body frame are closest to each other, from the other portion.

13. The wheelchair according to claim 2,
wherein a plurality of cross bars in parallel with each other make connection between the first body frame and the second body frame, the cross bar being one of the plurality of cross bars.

14. The wheelchair according to claim 3,
wherein the cross bar has a separation structure that allows removal of part or all of a portion that projects to an outside of at least one of the wheels rotatably supported by the first body frame and the wheel rotatably supported by the second body frame when the first body frame and the second body frame are closest to each other, from the other portion.

15. The wheelchair according to claim 3,
wherein a plurality of cross bars in parallel with each other make connection between the first body frame and the second body frame, the cross bar being one of the plurality of cross bars.

16. The wheelchair according to claim 8,
wherein the cross bar has a folding structure that allows folding of a portion that projects to an outside of at least one of the wheels rotatably supported by the first body frame and the wheel rotatably supported by the second body frame when the first body frame and the second body frame are closest to each other.

17. The wheelchair according to claim 8,
wherein the cross bar has a separation structure that allows removal of part or all of a portion that projects to an outside of at least one of the wheels rotatably supported by the first body frame and the wheel rotatably supported by the second body frame when the first body frame and the second body frame are closest to each other, from the other portion.

18. The wheelchair according to claim 9,
wherein a plurality of cross bars in parallel with each other make connection between the first body frame and the second body frame, the cross bar being one of the plurality of cross bars.

19. The wheelchair according to claim 14,
wherein a plurality of cross bars in parallel with each other make connection between the first body frame and the second body frame, the cross bar being one of the plurality of cross bars.

20. The wheelchair according to claim 1, wherein
the first body frame is a left body frame that has a main frame and a sub-frame, wherein the main frame and the sub-frame are joined on one side of the left body frame and the distance between the main frame and the sub-frame increases toward the other side of the left body frame, and
the second body frame is a right body frame that has a main frame and a sub-frame, wherein the main frame and sub-frame are joined on one side of the right body frame and the distance between the main frame and the sub-frame increases toward the other side of the right body frame.
